(19) United States
(12) Patent Application Publication
(10) Pub. No.: US 2018/0252828 A1
(43) Pub. Date: Sep. 6, 2018

(54) PERIMETER VIBRATION DETECTION SYSTEM AND METHOD

(71) Applicant: STANLEY CONVERGENT SECURITY SOLUTIONS, INC., Naperville, IL (US)

(72) Inventors: Robert C. Turnbull, Ontario (CA); Terance D. Brown, White Lake, Ontario (CA); Steve P. Horvath, Stittsville, Ontario (CA); Nicholas R. Turnbull, Ottawa, Ontario (CA)

(21) Appl. No.: 15/760,258

(22) PCT Filed: Jun. 30, 2016
(86) PCT No.: PCT/US16/40267

§ 371 Date: Mar. 15, 2018

Related U.S. Application Data
(60) Provisional application No. 62/219,974, filed on Sep. 17, 2015.

(51) Int. Cl. G01V 1/00; G08B 13/16; G01V 1/20; G01V 11/00

(52) U.S. Cl. CPC G01V 1/001; G08B 13/1663; G01V 1/181; G01V 11/002; G01V 1/20

(57) ABSTRACT

A vibration detection system with first and second vibration sensor assemblies. The first vibration sensor assembly is installed at a first depth below a ground surface. The second vibration sensor assembly is installed relative to the first vibration sensor assembly at a horizontal distance away from the first vibration sensor assembly and/or at a second depth below the ground surface, where the second depth is different than the first depth. The first and second vibration sensor assemblies are connected to at least one data logger, which is connected to a computer system. The computer system can calculate a location of a vibration source based on data received from the data logger.

### CROSS-REFERENCE TO RELATED APPLICATION

The present application derives priority from U.S. Patent Application No. 62/219,974, filed on Sep. 17, 2015, titled “PERIMETER VIBRATION DETECTION SYSTEM AND METHOD,” now pending and is fully incorporated herein by reference.

### FIELD OF THE INVENTION

The present invention relates to tunnel detection and perimeter vibration detection systems and methods for using such systems.

### BRIEF DESCRIPTION OF THE DRAWINGS

FIG. 1 is a perspective view of a perimeter vibration detection system.

FIG. 2 is a simplified top view of the system of FIG. 1.

FIG. 3 is a diagram showing the main elements of the perimeter vibration detection system.

FIG. 4 is a side view illustration an arrangement of vibration sensors.

### DESCRIPTION

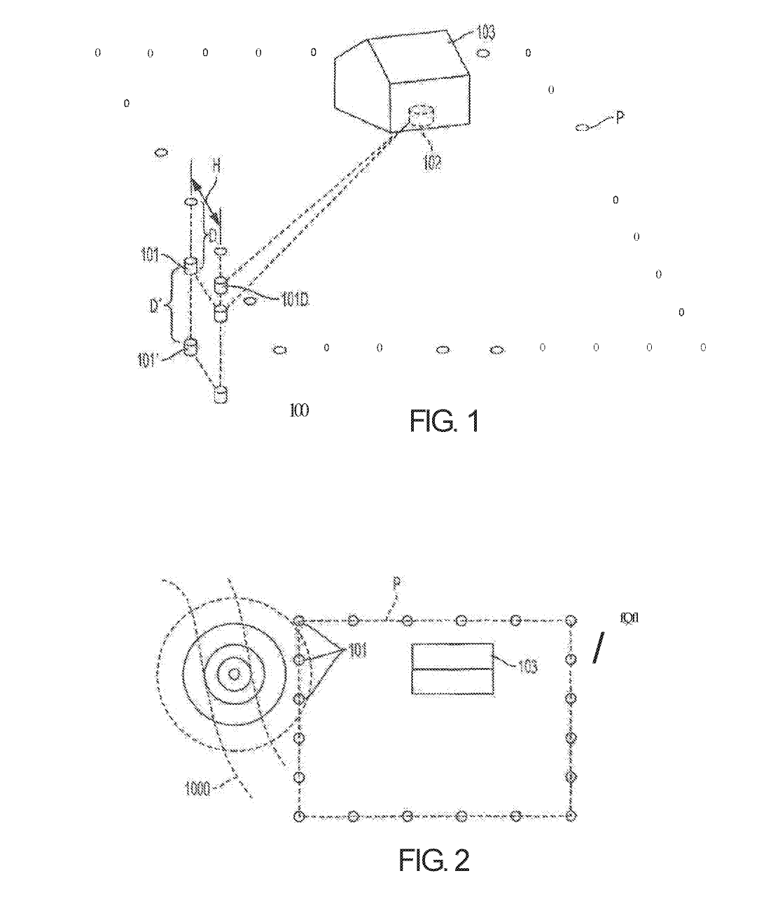

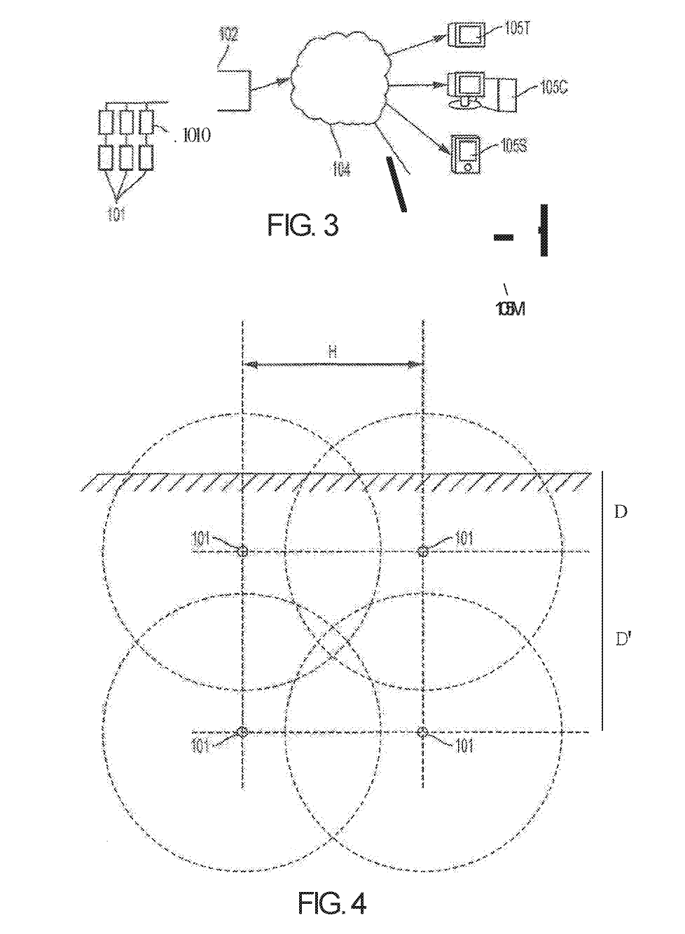

FIGS. 1-2 illustrate a perimeter vibration detection system 100 according to the invention. Perimeter vibration detection system 100 includes vibration sensors 101 that are installed along a border or around the perimeter P to be monitored. Persons skilled in the art will recognize that the vibration sensors 101 should have a wide enough frequency response in order to detect the anticipated or desired vibration. Vibration sensors 101 can be geophones, or other velocity sensors, accelerometers or MEMS sensors. Persons skilled in the art will select the type of vibration sensor 101 according to the application and installation method.

Vibration sensor 101 may include a sensor, signal processing circuitry and/or a housing to protect the sensor and/or circuitry. Vibration sensor 101 may also include power and wireless communication and/or a cable for providing communication and power to vibration sensor 101 and/or connecting vibration sensor 101 to a data logger 101D for communicating data thereto.

Referring to FIGS. 1-2 and 4, vibration sensors 101 are preferably installed on the surface or in the ground at a predetermined depth D from the ground surface, preferably between 5 meters and 100 meters, and typically do not to exceed 1000 meters, for a typical vibration sensor 101 that requires 3 volts and 5 milliamperes.

In addition vibration sensors 101 at the predetermined depth D are preferably disposed at a predetermined horizontal distance H from each other. This distance is preferably between 5 to 45 meters. Persons skilled in the art will recognize that vibration sensors with greater sensitivity can be installed at a greater distance apart. Similarly, persons skilled in the art will recognize that vibration sensors with lesser sensitivity can be installed at a smaller distance apart. Preferably, the horizontal distance is selected so that the detection areas of each adjacent vibration sensors 101 overlap. Persons skilled in the art will recognize that the resulting pattern of vibration sensors 101 will be chosen to provide adequate vibration detection of a specific area and/or perimeter. For example vibration sensors 101 can be installed in a straight line that is tens or hundreds of kilometers long, or around the perimeter of a specific area, as shown in FIGS. 1-2.

If it is desired to monitor vibration at a depth lower than depth D, persons skilled in the art will recognize that more vibration sensors 101′ can be disposed below vibration sensors 101. Preferably vibration sensors 101′ will be disposed below vibration sensors 101 at a predetermined depth, being at distance D′ from depth D. Distance D′ could be substantially equal to or greater than depth D, as shown in FIG. 4. Persons skilled in the art will recognize that more vibration sensors 101′ can be disposed at deeper depths, such as hundreds of meters in depth, as necessary.

Persons skilled in the art shall recognize that providing vibration sensors 101 under the ground surface provides a discrete method to monitor and/or protect a border or perimeter. Vibration sensors 101 may also detect vibrations caused by the creation (digging) of a tunnel 1000 (shown in FIG. 2), as well as vibrations caused by the use of the tunnel, such as people or traffic traveling therethrough, etc.

Vibration sensors 101 preferably have data loggers 101D to monitor and log vibration data. Data loggers 101D may be hard-wired to a computer system 102 in order to transmit vibration data received from vibration sensors 101, as well as data downloads from the data stored in the data loggers 101D. Preferably the hard-wired connection will be via serial or Ethernet cables. Persons skilled in the art will recognize that data loggers 101D may also be wirelessly connected to the computer system 102. Data loggers 101D may be both hard-wired and wirelessly connected to the computer system 102 in order to provide redundant channels of communication in order to maintain communications even if one channel failed. Preferably the wireless connection will be via cellular and/or Wi-Fi networks. Persons skilled in the art will recognize that data loggers 101D may be integrated, i.e., disposed in the same housing, as vibration sensors 101.

Data loggers 101D can be programmed to only send data/information once the sensed vibration at a particular vibration sensor 101 reaches a predetermined threshold level. The data logger 101D can send (or pass along) a message to the computer system 102 that effectively says “I'm vibration sensor 39. I have sensed vibration at level 45.” An adjacent vibration sensor 101 and/or data logger 101D can also send a message to the computer system 102 that effectively says “I'm vibration sensor 40. I have sensed vibration at level 42.” Both vibration sensors 101 (or data logger 101D) can also send a vibration profile to the computer system 102 that would indicate the sensed vibration over time.

Persons skilled in the art should recognize that data loggers 101D may be configured to have different trigger levels, recording times (determining the length of time to record after the vibration sensor 101 has exceeded the desired trigger level), sample rates, communication interfaces, etc. according to the desired application.

Because the computer system 102 has been programmed to know the locations of and distances between vibration sensors 39, 40, or can read this information from the sensors, the computer system 102 can then calculate the position (preferably within a three-dimensional space) of the epicenter of the vibration source using, for example, the time differential when vibrations were detected by the different vibration sensors 101 and/or the detected strength differential information for a vibration detected by the different vibration sensors 101. In one embodiment, vibration sensors 101 and/or data loggers 101D are synchronized so that the arrival time of a vibration at each vibration sensor 101 can be accurately compared.

The location of the vibration may also be calculated with an algorithm using multilateration,-vector intersection or other similar methods. These methods use the known distance between vibration sensors 101 to determine the point of origin. Multilateration generates a set of hyperbolic curves where vector intersection generates a set of straight lines. The intersection point of the hyperbolic curves or the vectors will be the point of origin of the vibration. With vibration sensors 101 located in multiple horizontal and vertical positions, the point of origin can be determined in three dimensional space.

Persons skilled in the art will recognize that the sampling rate of vibration sensors 101 has to be selected according to the granularity desired by the users, as the sample rate will affect the accuracy in locating the vibration source. For example, for a vibration frequency of 15-60 Hertz with a vibration velocity between 650-1200 meters per second, selecting a sample rate of 512 samples per second (sps) would result in a location resolution of about 2.3 meters. If a smaller resolution, i.e., more specific location, is desired, the sampling rate should be increased.

Computer system 102 can also compare the received vibration profiles to stored vibration profiles of known vibration sources, such as nearby cars, footsteps, construction activities, quarrying, excavation/tunneling, pile driving, blasting, tremors, tunnel construction (using shovels, picks, drills, jack hammers or heavy equipment, for example), tunnel usage, etc. Persons skilled in the art will recognize that the stored vibration profiles may be updated with new vibration profiles.

Persons skilled in the art will recognize that the velocity of the vibration through the ground should change based on the materials present underground. However the effect of these differences in underground materials should be minimized by the system due to the multiple vibration sensors 101.

Computer system 102 can then transmit an alarm report via a network 104, such as the internet, cellular phone network, etc., to a user's computer 105C or mobile device, such as a tablet 105T or smartphone 105S, via email and/or text. Alternatively, computer system 102 can provide information to a website showing the alarm report. Such alarm report can preferably display the location of the detected vibration source, as well as the probable cause for the detected vibration. In addition, computer system 102 can alert a monitoring station 105M (or a person at such monitoring station 105M) to call the user to relay the alarm report information.

Persons skilled in the art will recognize that vibration sensors 101 can be programmed with different threshold levels. For example it may be advantageous to raise the threshold levels for vibration sensors 101 near housing structure 103, where high vehicular and/or pedestrian traffic would be expected, to avoid frequent alarms. Alternatively computer system 102 may be programmed to ignore certain vibration profiles between some established time periods, e.g., 9 am to 5 pm.

The description of the invention is merely exemplary in nature and, thus, variations that do not depart from the gist of the invention are intended to be within the scope of the invention. Such variations are not to be regarded as a departure from the scope of the invention.

What is claimed is:

1: A vibration detection system comprising:
a first vibration sensor assembly comprising a first housing, and a first vibration sensor disposed within the first housing, the first vibration sensor assembly being installed at a first depth below a ground surface;
a second vibration sensor assembly comprising a second housing, and a second vibration sensor disposed within the second housing, the second vibration sensor assembly being installed relative to the first vibration sensor assembly at least one of a horizontal distance from the first vibration sensor assembly and a second depth below the ground surface, the second depth being different than the first depth;
the first and second vibration sensor assemblies being connected to at least one data logger;
a computer system connected to the at least one data logger for analyzing data received from the at least one data logger, wherein the computer system calculates a location of a vibration source.

2: The vibration detection system of claim 1, wherein the first depth is less than 1000 meters.

3: The vibration detection system of claim 2, wherein the first depth is between 5 and 100 meters.

4: The vibration detection system of claim 1, wherein the horizontal distance is between 5 and 45 meters.

5: The vibration detection system of claim 1, wherein the first vibration sensor assembly is wirelessly connected to the at least one data logger.

6: The vibration detection system of claim 1, wherein the first vibration sensor assembly is hard-wired connected to the at least one data logger.

7: The vibration detection system of claim 1, wherein the at least one data logger is contained within the first housing.

8: The vibration detection system of claim 1, wherein the at least one data logger is wirelessly connected to the computer system.

9: The vibration detection system of claim 1, wherein the at least one data logger is hard-wired connected to the computer system.

10: The vibration detection system of claim 1, wherein the at least one data logger transmits data to the computer system when an amplitude of detected vibration reaches a predetermined threshold.

11: The vibration detection system of claim 1, wherein when an amplitude of a detected vibration reaches a predetermined threshold, the computer system alerts a monitoring station.
